(19) United States
(12) Patent Application Publication
(10) Pub. No.: US 2005/0277448 A1
(43) Pub. Date: Dec. 15, 2005

(54) Soft buttons on LCD module with tactile feedback

(75) Inventors: Julio C. Castaneda, Coral Springs, FL (US); Donald W. Burnette, Sunrise, FL (US); Francis M. Staszesky, Fort Lauderdale, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/865,560

(22) Filed: Jun. 10, 2004

(51) Int. Cl. H04M 1/00; H04B 1/38; H04B 1/00; H04M 9/00; H04M 3/00

(52) U.S. Cl. 455/575.1; 455/90.3; 455/128; 379/447; 379/428.01; 379/330

(57) ABSTRACT

A display module (302) of an electronic device (100) provides tactile feedback force to a user while the user provides pressing force to a soft button (104, 105) on a display screen (102) of the display module (302). The pressing force from the user is transferred by the display module (302) via at least one switch contact surface (344) to at least one tactile switch (304, 305) cooperatively located relative to the at least one switch contact surface (344). The pressing force activates the at least one tactile switch (304, 305) while the at least one tactile switch (304, 305) provides tactile feedback force to the display module (302) that then transfers the tactile feedback force to the user. Additionally, the electronic device (300) detecting a simultaneous activation of at least two of the tactile switches (304, 305) indicates the user is pressing a soft button (320).

### FIELD OF THE INVENTION

The present invention generally relates to the field of liquid crystal display (LCD) modules and more particularly to LCD modules having soft buttons with tactile feedback.

### BACKGROUND OF THE INVENTION

A large number of personal electronics devices, such as cellular telephones, two-way radios, personal data assistants (PDAs), and portable computers have long used a display module as a means of transferring information to the user. This display module has become an ever increasing necessity in the telecommunications industry—especially for wireless phones and radios. In the past, the most desirable feature for a wireless phone was simply the ability to transfer information from one location to another. But today, the complexity of these devices has enabled them to become more than a means for communicating to remote locations; they have become an integral part of society. As such, many people rely on these devices for much more than merely talking. The phones of today are capable of providing computing functions, searching the internet, and storing a person's entire personal and/or business contacts for instant access.

As the telecommunication industry moves towards increasing the size and functionality of display modules, there is a need to display more information on the screen. In order to improve the ease of using the user interface (UI), there are typically soft buttons displayed on the module that are mapped to keypad buttons as part of the information that is displayed.

Touchscreens are available that allow for deployment of button functionality directly on the displays. Touchscreens have been widely used such as the applications of PDAs, kiosks, ATM machines, etc. However, in those embodiments there is typically only audio feedback (typically a tone is heard) when the screen is pressed—there is no tactile feedback. Because the feedback is typically only audible, there can be uncertainty for the user over whether the “button” actually activated whenever the device is in a silent or muted mode. As a result, the user may either 1) not activate a “button” when the user presses the touchscreen or 2) unintentionally activate the button multiple times with a “single” press on the touchscreen, thereby causing significant frustration and dissatisfaction.

Therefore a need exists to overcome the problems with the prior art as discussed above.

### SUMMARY OF THE INVENTION

Briefly, in accordance with the embodiments of the present invention, disclosed are a liquid crystal display module, mounting arrangement, and electronic device that provide tactile feedback force when an external source, such as a user, provides a switch activation force to the liquid crystal display module. The liquid crystal display module couples the switch activation force via a switch contact surface to at least one tactile switch cooperatively located relative to the at least one switch contact surface.

Alternative embodiments of the present invention include a means for rotationally or multi-axial rotationally coupling the liquid crystal display module to at least one tactile switch. Simultaneous activation of at least two of the tactile switches provides an independent switch function enabling three switch functions to be implemented with two actual switches.

The tactile switches can be either popple switches or spring loaded switch mechanisms, or other similar switches. Also, the liquid crystal display module may include a frame for holding together a lens, an LCD panel, and a lighting means. The lighting means may include at least one of an EL panel or other backlighting device, and a light pipe and/or a light diffuser coupled with at least one lamp, LED, and/or other light source.

Lastly, according to a new and novel method, an external source provides pressing force to a surface of a display module and then the display module transfers the pressing force to at least one tactile switch to activate the at least one tactile switch while the at least one tactile switch provides tactile feedback force to the display module that then transfers the tactile feedback to the external source.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of an electronic device that incorporates an LCD module with soft buttons that have tactile feedback, according to an embodiment of the present invention.

FIG. 2 is a block diagram of the electronic device of FIG. 1, according to an embodiment of the present invention.

FIG. 3 is a partial front view, and

FIG. 4 is a cut-away side view, of an exemplary cellular phone, having an LCD module with soft buttons that have tactile feedback, according to an embodiment of the present invention.

FIG. 5 is a partial front view, and

FIG. 6 is a cut-away side view, of an exemplary cellular phone, having an LCD module with soft buttons that have tactile feedback, according to an alternative embodiment of the present invention.

FIG. 7 is an operational flow diagram illustrating an exemplary operational sequence for an electronic device such as shown in FIG. 1, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

While the specification concludes with claims defining the features of the invention that are regarded as novel, it is believed that the invention will be better understood from a consideration of the following description in conjunction with the drawing figures, in which like reference numerals are carried forward.

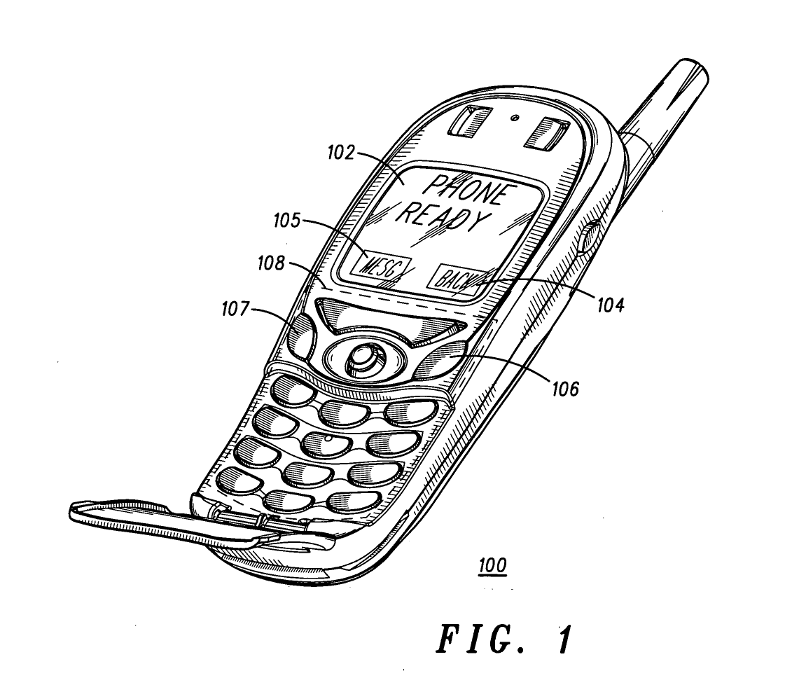

Referring to FIG. 1, the exemplary electronic device 100 comprises any device 100 with a display screen 102 including, for example, a wireless telephone, radio, PDA, computer, electronic organizer, pager, or other messaging device, and an electronic timepiece. An exemplary electronic device 100 may include “soft buttons” 104, 105, visible on the display screen 102. The soft buttons are visual representations of buttons, or other such target areas, displayed on the display screen 102, for indicating that a contact of the particular target area or soft button on the display screen 102 will activate/deactivate a function of the electronic device 100, similar to physical buttons on a user input device such as a keyboard or a key pad. These soft buttons 104, 105, according to the present example, are mapped via software to physical buttons 106, 107, located on the keypad 108. That is, a press on the BACK “soft” button 104 on the display screen 102, for example, operates the electronic device 100 similar to a press of a physical button 106 on the keypad 108. The other exemplary “soft” button on the display screen 102, i.e., the MESG “soft” button 105, would operate the electronic device 100 similar to the physical button 107. Please note that the terms “electronic device”, “phone”, “cell phone”, “radio”, and “wireless device”, may be used interchangeably throughout this document in reference to an exemplary electronic device.

Referring now to FIGS. 1 and 2, it can be seen that the exemplary electronic device 100 includes a controller 202, communicatively coupled with a user input interface 207. The user input interface 207 includes, in this example, two soft buttons 104,105, that are visible on a display screen 102 having touch screen capabilities, physical buttons 106, 107, that are part of a keypad 108, and an audio transducer 206 such as in a microphone (not shown) to receive and convert audio signals to electronic audio signals for processing in the electronic device 100 in a manner well known to those of ordinary skill in the art. The electronic device 100 also comprises a memory 210, a non-volatile (program) memory 211 containing at least one application program 217 and a database 219, and a power source interface 215.

The electronic device 100, according to an embodiment, comprises a wireless communication device 100 such as a cellular phone, a portable radio, a PDA equipped with a wireless modem, or other such type of wireless device. The wireless communication device 100 transmits and receives signals for enabling a wireless communication such as for a cellular telephone, in a manner well known to those of ordinary skill in the art. For example, when the wireless communication device 100 is in a “receive” mode, the controller 202 controls a radio frequency (RF) transmit/receive switch 214 that couples an RF signal from an antenna 216 through the RF transmit/receive (TX/RX) switch 214 to an RF receiver 204, in a manner well known to those of ordinary skill in the art. The RF receiver 204 receives, converts, and demodulates the RF signal, and then provides a baseband signal to an audio output module 203 and a transducer 205, such as a speaker, to output received audio from the speaker 205. In this way, for example, received audio can be provided to a user of the device 100. A receive operational sequence is normally under control of the controller 202 operating in accordance with computer instructions stored in the program memory 211, in a manner well known to those of ordinary skill in the art.

In a “transmit” mode, the controller 202, for example responding to a detection of a user input (such as a user pressing a button or switch on the keypad 108), controls the audio circuits and couples electronic audio signals from the audio transducer 206 of a microphone interface to transmitter circuits 212. The controller 202 also controls the transmitter circuits 212 and the RF transmit/receive switch 214 to turn ON the transmitter function of the electronic device 100. The electronic audio signals are thereby modulated onto an RF signal and coupled to the antenna 216 through the RF TX/RX switch 214 to transmit a modulated RF signal into a wireless communication system (not shown). This transmit operation enables the user of the device 100 to transmit, for example, audio communication into the wireless communication system in a manner well known to those of ordinary skill in the art. The controller 202 operates the RF transmitter 212, RF receiver 204, the RF TX/RX switch 214, and the associated audio circuits (not shown), according to computer instructions stored in the program memory 211

The controller 202 is communicatively coupled to the user input interface 207 for receiving user input from a user of the electronic device 100. It is important to note that the user input interface 207, in one exemplary embodiment, comprises the display screen 102 with the “GUI (Graphical User Interface) Buttons” 104 or “soft buttons” as also known in the art. The controller 202 is also communicatively coupled to the display screen 102 (such as a display screen of a liquid crystal display module) for displaying information to the user of the device 100. The display screen 102 therefore serves both as a user input device (to receive user input from a user) and as a user output device to display information to the user. The user input interface 207 couples data signals to the controller 202 based on the keys or buttons (including soft buttons) pressed by the user. The controller 202 is responsive to the data signals thereby causing functions and features under control of the controller 202 to operate in the device 100. The structure and function associated with the soft buttons on the display screen 102 will be discussed in more detail below.

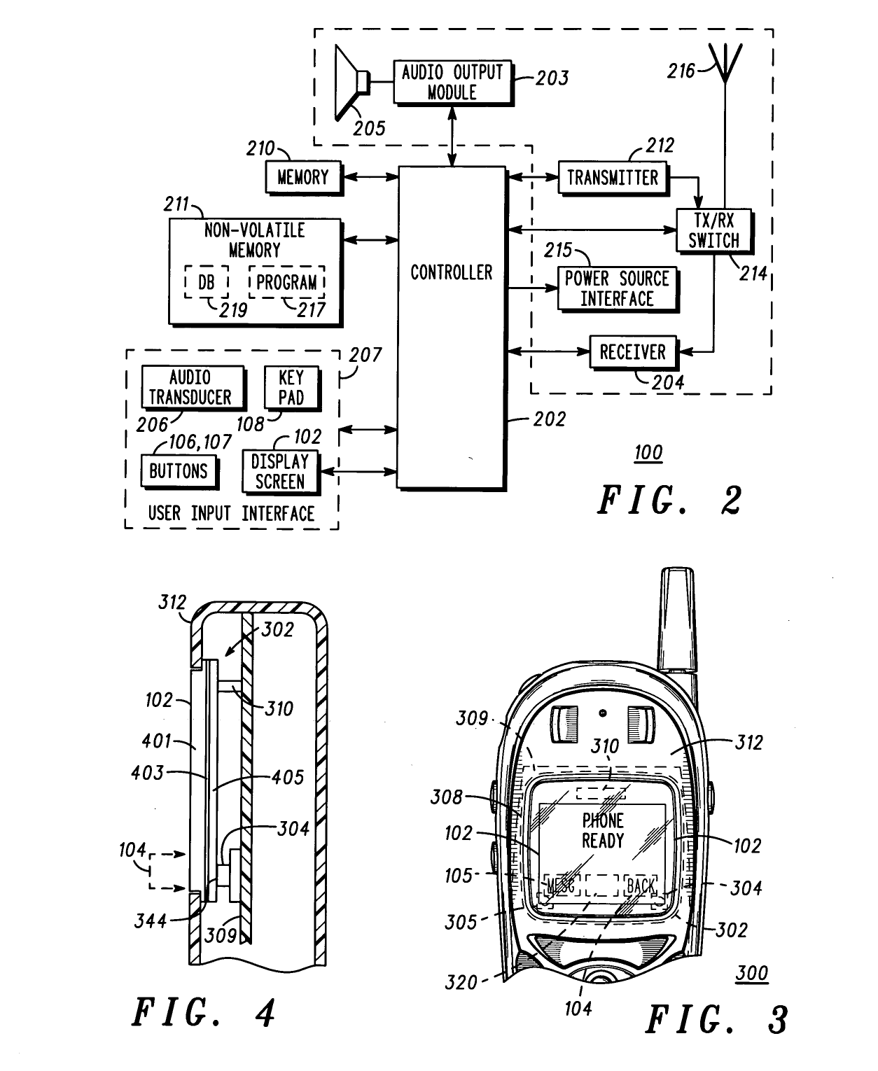

The present invention, according to an embodiment of an electronic device 300 shown in FIGS. 3 through 6, advantageously overcomes problems with the prior art by placing tactile switches 304, 305, under a liquid crystal display (LCD) module 302 so that when one of the soft buttons 104, 105, near the corners of the active area of the display screen 102 is pressed by the user, the user receives an audio feedback (such as by an audio signal emitted from the speaker 205) and also feels a tactile feedback while contacting the particular soft button 104, 105, that is being pressed. Since the user feels tactile feedback when pressing a soft button, 104, 105, the user makes a more natural determination of whether the soft button 104, 105, was affirmatively pressed by the user, similar to the user pressing a physical button 106, 107. This is a significant advantage of the present invention over the prior art. It provides a new and novel utility and natural ease of use of the device 100 to a user of the electronic device 300, as will be discussed in more detail below.

This soft button tactile feedback feature will be especially desirable by users of electronic devices 100 that are becoming smaller and smaller, such as cellular phones, to meet consumer demands for portability and miniaturization, and consequently such devices 100 need to use the display screen 102 as both a user output device (for displaying information to the user) and as a user input device (for receiving user input from the user). Due to its desirability by consumers, this feature will significantly enhance the commercial viability of any such electronic device 100.

The LCD module 302, in this example, includes a display screen 102 on a lens 401, an LCD panel 403, and a lighting device 405. The lighting device 405 may comprise, for example, one or more light sources, e.g., lamps or LEDs, arranged in combination with a light diffuser and/or a light pipe to spread light from the one or more light sources to illuminate the LCD panel 403 as visible through the lens 401. Optionally, the lighting device 405 may comprise a backlighting light source, such as an electro-luminescent (EL) panel that provides backlighting to the LCD panel 403 to enhance its visibility as visible through the lens 401. The lens 401, LCD panel 403, and lighting device 405, are all mounted and secured within a support frame 308, collectively constituting the LCD module 302. The LCD module 302 is mounted in the electronic device housing 312 in such a manner that the display module 302 can pivot or rotate about a point or axis to assist the active area of the display screen 102 to receive user input, as will be discussed in more detail below. According to the present example, the display module 302 is sandwiched between an exterior wall of the housing 312 of the electronic device 300 and a printed circuit board (PCB) 309.

The point or axis may comprise any means that allows rotational movement of the display screen 102. For example, a roll bar 310 can be located near one edge of the display module 302. In this example, the roll bar is located underneath, and coupled to, the display module 302. However, it should be obvious to one of ordinary skill in the art, in view of the present discussion, that the roll bar can alternatively be coupled to the display module 302 and located at the edge of the display module 302 or even above the edge of the display module 302, as long as the arrangement allows the display screen 102 to rotate about the main axis of the roll bar 310.

The opposite edge of the display module 302, according to this example, is supported near the two corners of the display module 302 by two tactile switches 304, 305. These tactile switches 304, 305, are preferably mounted on the printed circuit board (PCB) 309 and mechanically contact the underside of the display module 302 via at least one switch contact surface 344 (e.g., at the backside of the display module 302).

The tactile switches 304, 305, may be, for example, deforming metal bubble-top switches (“popples”) or regular spring loaded switch mechanisms. Other types of switch mechanisms should become obvious to those of ordinary skill in the art in view of the present discussion. This arrangement of the tactile switches 304, 305, and the display module 302 allows the electronic device 300 to detect a pressing force on a soft button 104, 105 (such as from a user pushing on top of the display screen 102 at either corner of the active area of the display screen 102). For example, when a user presses on the BACK soft button 104 on the display screen 102, the pressing force sourced from the user will transfer through the display module 302 to the tactile switch 304 (see FIG. 4) and activate the tactile switch 304. The display module 302 rotates about the roll bar 310 and allows the pressing force to couple to the tactile switch 304 at the switch contact surface 344.

Additionally, the tactile switch 304 provides a tactile force back to the display module 302 which then couples the tactile force to the user thereby providing tactile feedback while the user presses the soft button 104. Since the user feels tactile feedback when pressing the soft button 104, the user makes a more natural determination of whether the soft button 104 was affirmatively pressed by the user, similar to the user pressing a physical button 106, 107.

While the user presses the BACK soft button 104 and couples pressing force to the tactile switch 304, little or no pressing force is contemporaneously delivered to the other tactile switch 305 underneath the MESG (i.e., Message) soft button 105. The display module 302 may have some flexibility or deformability (and/or the roll bar 310) to help enable this feature. Any pressing force that may be distributed by the display module 302 to the other tactile switch 305 is insufficient to activate the other tactile switch 305. In a similar way, while a user presses the MESG soft button 105 the display module 302 couples pressing force sufficient to activate the tactile switch 305 underneath the MESG soft button 105 while not transferring appreciable tactile force to activate the tactile switch 304 underneath the BACK soft button 104. In this way, the electronic device 100 is able to affirmatively detect a press of one of the two soft buttons 104, 105. Additionally, while activating one of the tactile switches 304, 305, the user receives tactile feedback to naturally indicate to the user that the particular soft button 104, 105, being pressed is also being detected by the electronic device 300. This is a significant advantage of the present invention not available in any other known prior art electronic devices.

According to an embodiment of the present invention, an “additional” middle soft button 320 can be provided near the edge of the display screen 102. The middle soft button 320 is located generally between the two corner soft buttons 104, 105, to provide a third separate soft button 320. In this case, the user presses the middle soft button 320 and then the display module 302 couples pressing force to both corner tactile switches 304, 305, sufficient to activate both corner tactile switches 304, 305, substantially at the same time. The simultaneous activation of both tactile switches 304, 305, can be mapped to an independent switch function corresponding to the middle soft button 320. This soft button configuration, according to the present example, effectively allows three separate soft button functions 104, 105, 320, to be detected by the electronic device 300 while using only two physical tactile switches 304, 305. Other configurations of soft buttons and arrangements of the display module 302 and tactile switches 304, 305, should become obvious to those of ordinary skill in the art in view of the present discussion.

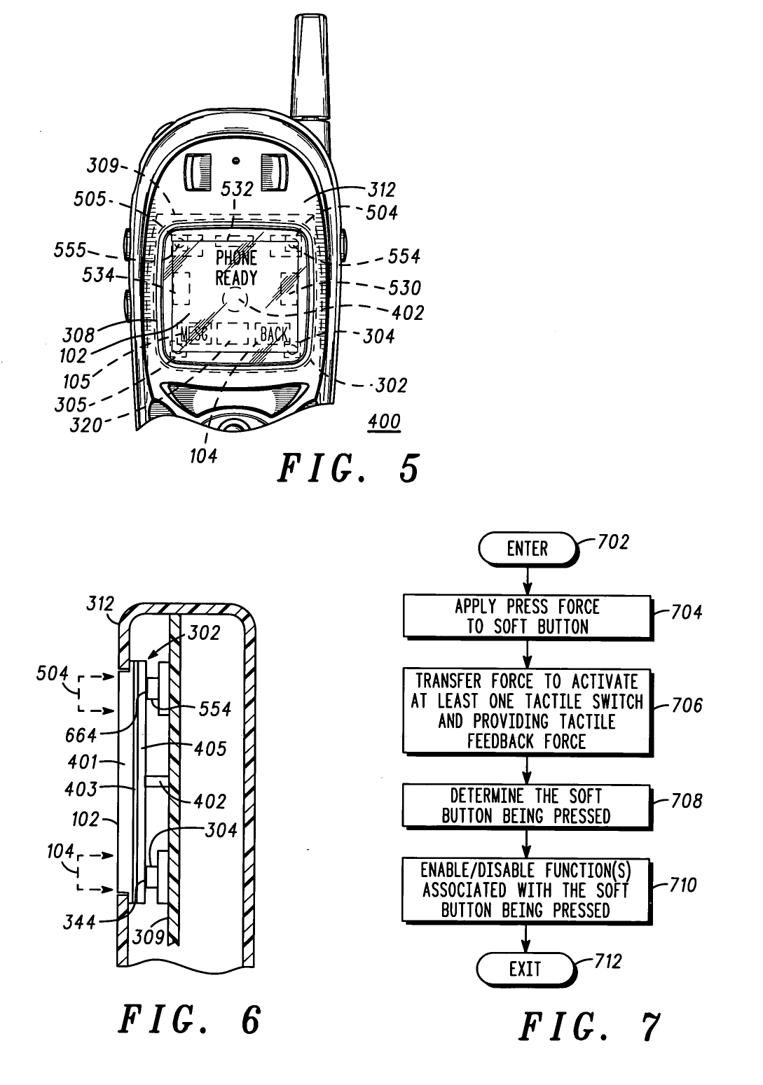

An alternative exemplary embodiment is shown in FIGS. 5 and 6. In this configuration of an electronic device 400, four tactile switches 304, 305, 554, 555, are respectively located near each of the four corners of the active area of the display screen 102. The display screen 102 of the display module 302, according to the present example, is free to pivot or rotate in a multi-axes manner about a center support point 402. The support point 402, in this example, is provided by a fixed structure that is mounted on the PCB 309 and generally located about the center region of the display module 302 when mounted in the electronic device 400. Four soft buttons 104, 105, 504, 505, are provided above the four tactile switches 304, 305, 554, 555, respectively located near each of the four corners of the active area of the display screen 102. When any one of the four soft buttons 104, 105, 504, 505, is pressed, the display module 302 transfers pressing force to activate only the respective one tactile switch 304, 305, 554, 555, located immediately below the pressed soft button 104, 105, 504, 505, while not activating any of the other tactile switches 304, 305, 554, 555, located away from the particular soft button 104, 105, 504, 505, being pressed. For example, when the BACK soft button 104 is pressed by the user, the pressing force is transferred by the display module 302 sufficient to activate the tactile switch 304 immediately below the BACK soft button 104. However, while pressing the BACK soft button 104 the display module 302 does not transfer sufficient pressing force to activate any of the other tactile switches 554, 555,305. The display module 302 transfers the pressing force to the particular tactile switch 304 under the particular soft button 104 via at least one switch contact surface 344. As another example, when a user presses another soft button 504 the display module 302 would transfer pressing force to a particular tactile switch 554 located under the particular soft button 504 via at least one switch contact surface 664.

Additionally, according to the present example, and as can be most fully viewed in FIG. 5, a middle soft button 320, 530, 532, 534, can be provided near the middle section of each of the four edges of the active area of the display screen 102. That is, a first middle soft button 320 can be provided between two corner soft buttons 104, 105, near the lower edge of the display screen 102. The simultaneous activation of both tactile switches 304, 305, can be mapped to an independent switch function corresponding to the middle soft button 320. A second middle soft button 530 can be provided between two corner soft buttons 104, 504, near the right edge of the display screen 102. The simultaneous activation of both tactile switches 304, 554, can be mapped to an independent switch function corresponding to the middle soft button 530. A third middle soft button 532 can be provided between two corner soft buttons 504, 505, near the top edge of the display screen 102. The simultaneous activation of both tactile switches 554, 555, can be mapped to an independent switch function corresponding to the middle soft button 532. Lastly, according to the present example, a fourth middle soft button 534 can be provided between two corner soft buttons 505, 105, near the left edge of the display screen 102. The simultaneous activation of both tactile switches 555, 305, can be mapped to an independent switch function corresponding to the middle soft button 534. In summary, each of the middle soft buttons 320, 530, 532, 534, can be mapped along each side of the display screen 102 to correspond to simultaneously providing pressing force sufficient to activate both of the tactile switches 304, 305, 554, 555, along that particular edge of the display screen 102. The display module 302 is free to pivot or rotate in a multi-axes manner, in this example about the center support point 402, to allow the display module 302 to transfer sufficient pressing force being applied to any one of the four middle soft buttons 320, 530, 532, 534, to activate a corresponding pair of the tactile switches 304, 305, 554, 555, along the particular edge of the display screen 102.

While activating the particular pair of tactile switches 304, 305, 554, 555, along the particular edge of the display screen 102, there is insufficient pressing force transferred to the other tactile switches 304, 305, 554, 555, away from the particular edge of the display screen 102 to activate any of these other tactile switches. In this way, this exemplary implementation provides up to eight separate soft buttons 104, 105, 504, 505, 320, 530, 532, 534, that can be presented on the display screen 102 while physically requiring only four physical tactile switches 304, 305, 554, 555. The center point 402 may be physically present by way of a support post. Alternatively, the display screen 102 may rest solely upon the four tactile switches 304, 305, 554, 555, and freely pivot or rotate in a multi-axes manner thereon, with no actual supporting structure at the center point 402 location. Other alternative structural and functional implementations and arrangements of soft buttons and physical tactile switches should be obvious to those of ordinary skill in the art in view of the present discussion.

With reference to FIG. 7, a new and novel method of utilizing a display module 302 according to the present invention will be discussed below. The method is entered, at step 702, and then pressing force is applied to a soft button 104 on a display screen 102 of a display module 302, at step 704. The display module 302, at step 706, transfers the pressing force to at least one tactile switch 304 and activates the tactile switch 304. Contemporaneously, tactile feedback force is provided by the at least one tactile switch 304, which is then transferred by the display module 302, and provided back to the source of the pressing force, e.g., the user pressing the soft button 104. An electronic device 300, at step 708, determines the pressing of the soft button 104 by detecting the activation of the at least one tactile switch 304. As has been discussed above, as another example, a pressing force applied to a soft button 320 may be transferred by the display module 302 sufficient to activate two tactile switches 304, 305. The electronic device 300, at step 708, would determine the pressing of the soft button 320 by detecting the activation of the two tactile switches 304, 305. Lastly, at step 710, the electronic device 300 enables and/or disables functions(s) associated with the soft button 104 being pressed, and then the method exits, at step 712.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments.

Furthermore, it is intended that the appended claims cover any and all such applications, modifications, and embodiments within the scope of the present invention.

1. A display module mounting arrangement comprising:
a mounting structure;
a display module, movably coupled to the mounting structure, the display module including a display screen and at least one switch contact surface; and
at least one tactile switch cooperatively located relative to the at least one switch contact surface such that when an external source provides a switch activation force to the display screen the display module couples switch activation force via the at least one switch contact surface to the at least one tactile switch to activate the at least one tactile switch and to provide tactile feedback force from the at least one tactile switch via the display module to the external source.

2. The display module mounting arrangement of claim 1, wherein the display module comprises a liquid crystal display module, and wherein the mounting structure comprises a rotational coupling means for rotationally coupling the liquid crystal display module with the mounting structure, the switch activation force provided to the display screen causing the liquid crystal display module to rotate relative to the rotational coupling means thereby coupling the switch activation force via the at least one switch contact surface to the at least one tactile switch to activate the at least one tactile switch and to provide tactile feedback force from the at least one tactile switch via the liquid crystal display module to the external source.

3. The display module mounting arrangement of claim 1, wherein the display module comprises a liquid crystal display module, and wherein the mounting structure comprises a multi-axes rotational coupling means for multi-axes rotationally coupling the liquid crystal display module with the mounting structure, the switch activation force provided to the liquid crystal display module causing the liquid crystal display module to rotate relative to the multi-axes rotational coupling means in one of a plurality of rotational axes, thereby coupling the switch activation force via the at least one switch contact surface to the at least one tactile switch to activate the at least one tactile switch and to provide tactile feedback force from the at least one tactile switch via the liquid crystal display module to the external source.

4. The display module mounting arrangement of claim 1, wherein the at least one tactile switch comprises at least one of a popple switch and a spring loaded switch.

5. A display module mounting arrangement comprising:
a mounting structure;
a display module, movably coupled to the mounting structure, the display module including a display screen and at least one switch contact surface; and
a plurality of tactile switches cooperatively located relative to the at least one switch contact surface such that when an external source provides a switch activation force to the display screen the display module couples the switch activation force via the at least one switch contact surface to simultaneously activate at least two of the plurality of tactile switches, the simultaneous activation being mapped to an independent switch function, and to provide tactile feedback force from the plurality of tactile switches via the display module to the external source.

6. The display module mounting arrangement of claim 5, wherein the at least one tactile switch comprises at least one of a popple switch and a spring loaded switch.

7. A display module comprising:
a display screen; and
at least one switch contact surface, the at least one switch contact surface cooperatively located relative to at least one tactile switch such that when an external source provides a switch activation force to the display screen the display module couples the switch activation force via the at least one switch contact surface to the at least one tactile switch to activate the at least one tactile switch and to provide tactile feedback force from the at least one tactile switch via the display module to the external source.

8. The display module of claim 7, wherein the display module comprising rotational coupling means for rotationally coupling the display module with a mounting structure for providing switch activation force from an external source to the display screen to cause the display module to rotate relative to the rotational coupling means thereby coupling the switch activation force via the at least one switch contact surface to the at least one tactile switch to activate the at least one tactile switch and to provide tactile feedback force from the at least one tactile switch via the display module to the external source.

9. The display module of claim 8, wherein the rotational coupling means comprises a multi-axes rotational coupling means for multi-axes rotationally coupling the display module with the mounting structure for providing switch activation force from an external source to the display screen to cause the display module to rotate relative to the multi-axes rotational coupling means in one of a plurality of rotational axes thereby coupling the switch activation force via the at least one switch contact surface to the at least one tactile switch to activate the at least one tactile switch and to provide tactile feedback force from the at least one tactile switch via the display module to the external-source.

10. The display module of claim 8, wherein the display module comprises a liquid crystal display module comprising:
a lens providing an active area of the display screen;
a liquid crystal display panel; and
a lighting device for illuminating the liquid crystal display module as viewed via the display screen.

11. The display module of claim 10, wherein the lighting device comprises at least one of an electro-luminescent panel, a light diffuser, and a light pipe.

12. An electronic device comprising:
electronic circuits;
a display module mounting structure;
a display module, electrically coupled with the electronic circuits and movably coupled with the display module mounting structure, the display module including a display screen and at least one switch contact surface; and
at least one tactile switch cooperatively located relative to the at least one switch contact surface such that when an external source provides a switch activation force to the display screen the display module couples switch activation force via the at least one switch contact surface to the at least one tactile switch to activate the at least one tactile switch and to provide tactile feedback force from the at least one tactile switch via the display module to the external source.

13. The electronic device of claim 12, wherein the display module comprises a liquid crystal display module, and wherein the display module mounting structure comprises a rotational coupling means for rotationally coupling the liquid crystal display module with the display module mounting structure, the switch activation force provided to the display screen causing the liquid crystal display module to rotate relative to the rotational coupling means thereby coupling the switch activation force via the at least one switch contact surface to the at least one tactile switch to activate the at least one tactile switch and to provide tactile feedback force from the at least one tactile switch via the liquid crystal display module to the external source.

14. The electronic device of claim 12, wherein the display module comprises a liquid crystal display module, and wherein the display module mounting structure comprises a multi-axes rotational coupling means for multi-axes rotationally coupling the liquid crystal display module with the display module mounting structure, the switch activation force provided to the liquid crystal display module causing the liquid crystal display module to rotate relative to the multi-axes rotational coupling means in one of a plurality of rotational axes, thereby coupling the switch activation force via the at least one switch contact surface to the at least one tactile switch to activate the at least one tactile switch and to provide tactile feedback force from the at least one tactile switch via the liquid crystal display module to the external source.

15. The electronic device of claim 12, wherein the at least one tactile switch comprises at least one of a popple switch and a spring loaded switch.

16. The electronic device of claim 12, wherein the display module comprises a liquid crystal display module comprising:
a lens providing an active area of the display screen;
a liquid crystal display panel; and
a lighting device for illuminating the liquid crystal display module as viewed via the display screen.

17. The electronic device of claim 16, wherein the lighting device comprises at least one of an electro-luminescent panel, a light diffuser, and a light pipe.

18. The electronic device of claim 12, wherein the electronic device comprises at least one of a wireless telephone, a radio, a personal data assistant, a computer, an electronic organizer, a pager, and an electronic timepiece.

19. An electronic device comprising:
electronic circuits;
a display mounting structure;
a display module, electrically coupled with the electronic circuits and movably coupled with the display module mounting structure, the display module including a display screen and at least one switch contact surface; and
a plurality of tactile switches cooperatively located relative to the at least one switch contact surface such that when an external source provides a switch activation force to the display screen the display module couples the switch activation force via the at least one switch contact surface to at least two of the plurality of tactile switches to simultaneously activate at least two of the plurality of tactile switches, the simultaneous activation being mapped to an independent switch function, and to provide tactile feedback force from the plurality of tactile switches via the display module to the external source.

20. The electronic device of claim 19, wherein the plurality of tactile switches comprises at least one of a popple switch and a spring loaded switch.

21. The electronic device of claim 19, wherein the display screen provides a user interface for receiving user input for the electronic device.

22. The electronic device of claim 19, wherein the electronic device comprises at least one of a wireless telephone, a radio, a personal data assistant, a computer, an electronic organizer, a pager, and an electronic timepiece.

23. A method for activating a tactile switch comprising:
applying a pressing force from a source to a soft button on a display screen of a display module;
transferring pressing force from the display module to at least one tactile switch and thereby activating the at least one tactile switch;
providing tactile feedback force from the at least one tactile switch to the display module; and
transferring tactile feedback force from the display module to the source.

24. The method of claim 23, wherein the at least one tactile switch comprises a plurality of tactile switches, and wherein the display module transfers pressing force to one of the plurality of tactile switches sufficient to activate it while not providing sufficient pressing force to, and not activating, any other of the plurality of tactile switches.

25. The method of claim 23, wherein the display module transfers the pressing force to the at least one tactile switch by rotating around an axis.
